(19) United States
(12) Patent Application Publication
(10) Pub. No.: US 2009/0208320 A1
(43) Pub. Date: Aug. 20, 2009

(54) METHOD OF SEPARATING A NUMBER OF VIALS FROM A PLURALITY OF VIALS DISPOSED IN SEVERAL ROWS AND APPARATUS THEREFOR

(75) Inventors: Alexander Wagner, Lohra (DE); Ralf Battenberg, Fronhausen (DE)

Correspondence Address: HANLEY, FLIGHT & ZIMMERMAN, LLC, 150 S. WACKER DRIVE, SUITE 2100, CHICAGO, IL, 60606, US

(73) Assignee: ACCURO GmbH, Fronhausen (DE)

(21) Appl. No.: 12/371,832

(22) Filed: Feb. 16, 2009

(30) Foreign Application Priority Data
Feb. 19, 2008 (DE) 102008009993.7

(51) Int. Cl. B65G 47/34

(52) U.S. Cl. 414/814; 414/639

(57) ABSTRACT

A method of separating a number of vials from a plurality of vials disposed in several rows is disclosed. The vials being at first caused to move onto one transfer plane and being then caused to move further beyond the transfer plane in order for the vials intended to be separated to reach a surface adjoining the transfer plane, via the transfer plane, and that the remaining vials remain on the transfer plane. Providing a method of the type mentioned herein above, ensures that the vials are evacuated properly and completely without discrete vials toppling. This is achieved in that the vials still standing on the transfer plane adjacent the surface are next lifted or that the surface is lowered in order for the vials remaining on the transfer plane not to touch the surface.

### CROSS REFERENCE TO RELATED APPLICATION

This application is a non-provisional application claiming priority from German Application Serial No. DE 10 2008 009 003.7, filed Feb. 19, 2008, and incorporated herein by reference in its entirety.

### FIELD OF THE DISCLOSURE

The present disclosure relates to a method of separating a number of vials and to an apparatus for carrying out said method.

### BACKGROUND OF RELATED ART

An apparatus for separation and controlled evacuation of a number of vials is known from DE 10 2005 019 985 A1 wherein a plurality of vials disposed in several rows are pushed onto a transfer plane by means of a discharge pusher. There, a transport means takes hold of the vials standing in the first row and transports them onto an evacuating conveyor belt from where the vials are evacuated for further processing.

For this purpose, a transport means formed from a thin steel sheet is pushed under the foremost row of vials deposited on a transfer plane, then, the vials are lifted by the transport means and are transferred onto an evacuating conveyor belt before a pusher is brought close to the vials and before the transport means is removed from underneath the vials, said vials being pushed against the pusher and being prevented from toppling.

When displaced, the vials of different rows are pressed against each other so that small gaps are forming into which a vial of another row may partially enter. When a transport means is then engaged underneath the vials, it may happen that the transport means only engages partially beneath a vial or that part of a vial of another row comes to stand on the transport means. When the transport means is then lifted, it may happen that a vial topples and thus becomes useless.

According to another method of separating vials, the vials disposed in several rows are pushed so far over a transfer plane that the vials to be separated arrive on a surface, in particular on an evacuating conveyor belt. Here again, the discrete vials are displaced against each other in such a manner that singular vials partially project into neighbouring rows. If the evacuating conveyor belt is started in order to evacuate the vials, it may happen that vials partially standing on the evacuating conveyor belt and belonging to the next row, which is not to be evacuated, are caused at least to move along therewith. If vials that are to be evacuated then hit the vials standing undesirably partially on the evacuating conveyor belt, it may happen that one vial topples, thus becoming useless.

The loss of a vial is undesirable, inter alia, because the relative position of the discrete vials with respect to each other is changed so that the entire documentation gets mixed up.

### BRIEF DESCRIPTION OF THE DRAWINGS

FIG. 1 is a sectional schematic side view of a first embodiment of an apparatus of the invention at a first moment in time, taken along section line I-I in FIG. 2.

FIG. 2 is a top view of the apparatus as shown in FIG. 1.

FIG. 3 shows the apparatus as shown in FIG. 1 at a second moment in time.

FIG. 4 shows an enlarged detail of the apparatus shown in FIG. 3, taken along line IV in FIG. 3.

FIG. 5 is a sectional schematic side view of a second embodiment of an apparatus of the invention at a first moment in time, taken along section line V-V in FIG. 6.

FIG. 6 is a top view of the apparatus shown in FIG. 5.

FIG. 7 shows the apparatus shown in FIG. 5 at a second moment in time.

FIG. 8 shows an enlarged detail of the apparatus shown in FIG. 7, taken along line VIII in FIG. 7.

FIG. 9 is a sectional schematic side view of a third embodiment of an apparatus of the invention at a first moment in time.

FIG. 10 shows the apparatus shown in FIG. 9 at a second moment in time.

FIG. 11 shows the apparatus shown in FIG. 9 at a third moment in time.

FIG. 12 shows the apparatus shown in FIG. 9 at a fourth moment in time.

FIG. 13 shows the apparatus shown in FIG. 9 at a fifth moment in time.

FIG. 14 shows the apparatus shown in FIG. 9 at a sixth moment in time.

FIG. 15 shows the apparatus shown in FIG. 9 at a seventh moment in time.

FIG. 16 is a sectional, schematic side view of a fourth embodiment of an apparatus of the invention at a first moment in time.

FIG. 17 shows the apparatus shown in FIG. 16 at a second moment in time.

FIG. 18 shows the apparatus shown in FIG. 16 at a third moment in time.

FIG. 19 shows the apparatus shown in FIG. 16 at a fourth moment in time.

FIG. 20 shows the apparatus shown in FIG. 16 at a fifth moment in time.

### DETAILED DESCRIPTION

The following description of the disclosed examples is not intended to limit the scope of the invention to the precise form or forms detailed herein. Instead the following description is intended to be illustrative of the principles of the invention so that others may follow its teachings.

It is an object of the present disclosure to provide a method and an apparatus of the type mentioned herein above which ensures orderly and complete evacuation of the vials without individual vials toppling.

A method carried out according to this technical teaching and an apparatus implemented according to this technical teaching have the advantage that only those vials are standing on the surface which are to be evacuated and that the other vials have no contact with the evacuating conveyor belt. When the evacuating conveyor belt is started, only the vials that are to be evacuated are being moved and the other vials are no longer moved along. Accordingly, when the evacuating conveyor belt is being started, there are much less forces acting on the remaining vials so that toppling of a single vial is avoided.

In the case of an apparatus with a transport means, the technical teaching proposed herein has the advantage that by lifting the vials adjacent the surface the transport means only seizes the vials to be separated, thus preventing a remaining vial from toppling.

If the vials adjacent the surface are lifted by lifting or pivoting the transfer plane, one obtains the advantage that the edge of the transfer plane, which is turned toward the evacuating conveyor belt, forms an abutment so that, when the thin transport means is engaged beneath the vials, displacement of the vials toward the transfer plan is prevented. Through this abutment, all the vials are aligned in one line on the one side and on the other side the vials are prevented from slipping off into other rows. As a result, it is made certain that all the vials of the row located on the buffer surface are being seized by the transport means and are placed onto the evacuating conveyor belt. This certainly is particularly important for documentation for the freeze-drying process to be documented properly and according to legal regulations.

In an alternative embodiment, only the vials located directly on the surface are being lifted. For this purpose, a lifting apparatus such as a sword is provided between the transfer plane and the surface. This sword is applied to the part of the vials projecting beyond the transfer plane, thus lifting these corresponding vials for these vials to be lifted from the surface on which they have been placed.

In an advantageous developed implementation the transfer plane is divided into two parts so that part of the transfer plane is rigidly mounted and remains unchanged whilst the other part, which is adjacent the buffer surface, is mounted for pivotal movement for an edge of this part of the transfer plane, which is turned toward the transport means, to be lifted accordingly in order to act as an abutment for the vials.

In another embodiment, a light barrier for detecting the arrival of the vials is disposed above the surface. The vials, which come from the freeze-drying plant, are thereby moved onto the transfer plane by means of a large pusher until the foremost row is detected by the light barrier. Then, the movement of all the vials is set and since the buffer surface is dimensioned for one single row of vials to find place, the edge of the transfer plane turned toward the evacuating conveyor belt can then be lifted in order to make it possible for the transport means to engage underneath the vials.

Further advantages of the method of the invention and of the apparatus of the invention will become apparent in the appended drawings and in the following description of embodiments thereof. Likewise, the invention lies in each and every novel feature or combination of features mentioned above or described herein after. The embodiments discussed herein are merely exemplary in nature and are not intended to limit the scope of the invention in any manner.

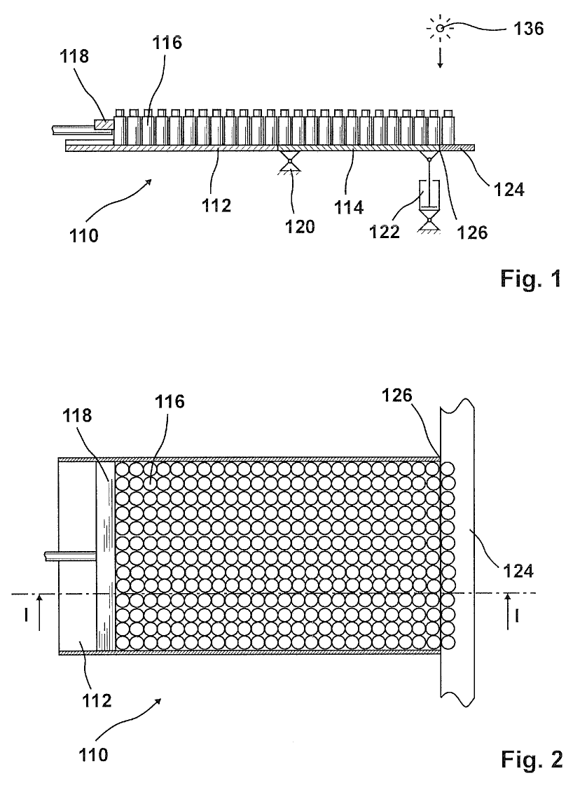

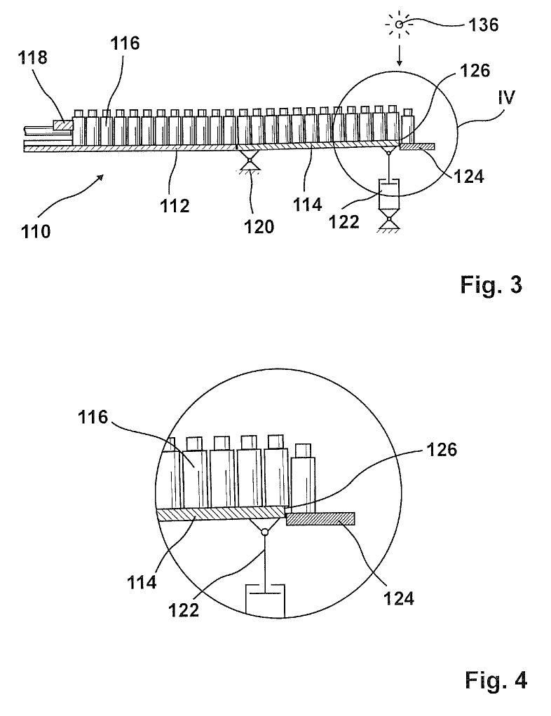

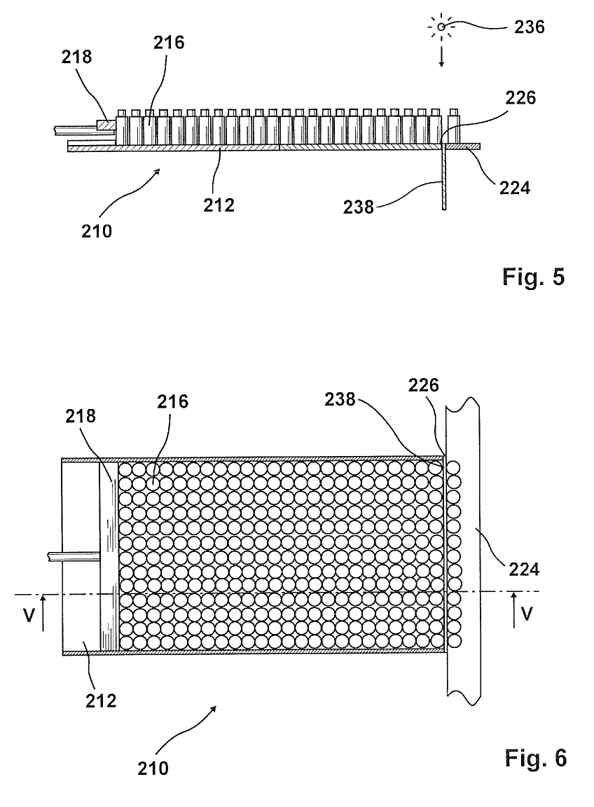

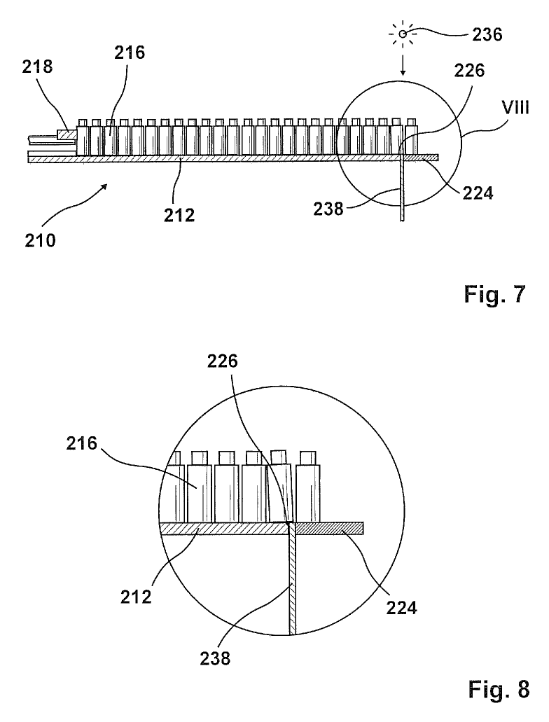

In FIGS. 1 through 4, a first embodiment of an apparatus for separating a number of vials from a plurality of vials disposed in several rows is shown in a schematic view, said apparatus incorporating a transfer plane 110 made from two parts, one first rigid part 112 and one second pivotally mounted part 114. Immediately adjacent to said transfer plane 110 there is adjoined an evacuating conveyor belt 124 on which the vials 116 can be evacuated for further processing.

At first, the vials 116 are pushed onto the transfer plane 110 by means of a discharge pusher 118 and the vials 116 are pushed further until the foremost row of vials 116 come to stand on the evacuating conveyor belt 124. This is sensed by a light barrier 136, said light barrier 136 then delivering a signal to the discharge pusher 118 in order to stop the discharge pusher 118. Next, the part 114 of the transfer plane 110, which is carried on the joint 120 and on the reciprocating piston 122, is caused to pivot by the extending reciprocating piston 122 so that an edge 126 of part 114, which is turned toward the evacuating conveyor belt 124, is lifted about 2 mm.

As can be seen in particular from FIG. 2, the vials 116 are disposed in rows. The width of the transfer plane 110 is chosen for a precisely determined number of vials 116 to fit in a row. However, due to production tolerances, the discrete vials 116 are not exactly of the same size so that the respective rows of vials 116 are of different lengths. When the discharge pusher 118 displaces the plurality of vials 116, it may happen that vials 116 of neighbouring rows do not strike each other in their center, but with a slight offset. Put another way, it happens that discrete vials 116 enter into smaller gaps between vials 116 of neighbouring rows, this resulting in that the row of vials standing close to the evacuating conveyor belt 124 for example comes to stand partially on the evacuating conveyor belt 124 when already all the vials 116 to be separated are located on the evacuating conveyor belt 124. If the evacuating conveyor belt 124 were now caused to move, forces would act onto this part of the projecting vials 116, which could possibly cause individual vials 116 to topple. For this reason, the part 114 of the transfer plane 110 is lifted by means of the reciprocating piston 122 so far (preferably 2 mm) that the vials 116 still standing on the transfer plane 110 are lifted from the evacuating conveyor belt 124 and are no longer in touching contact therewith. If the evacuating conveyor belt 124 is then switched on to evacuate the separated vials 116, no forces from the evacuating conveyor belt 124 can act onto the vials 116 standing on the transfer plane 110.

Since, depending on their size, the vials on the transfer plane 110 only project 3 mm at the most beyond the transfer plane, it is possible for the separated vials 116 standing on the evacuating conveyor belt 124 to glide past the vials 116 standing on the transfer plane 110 without vials 116 toppling during evacuation.

Likewise, in a second embodiment of an apparatus of the invention for separating a number of vials, the vials 216 are pushed onto a transfer plane 210 by a discharge pusher 218 until a first row of vials 216 comes to stand on an evacuating conveyor belt 224. Said first row is detected by a light barrier 236 which then stops the discharge pusher 218 accordingly. It is understood that in this embodiment a front edge 226 of the transfer plane 210 is aligned flush with the evacuating conveyor belt 224.

In this embodiment, between the transfer plane 210 and the evacuating conveyor belt 224, there is installed a lifting apparatus configured to be a sword 238. This sword 238 is disposed for vertical displacement, the blade of the sword, which is oriented upward, being aligned flush with the top side of the transfer plane 210 or with the top side of the evacuating conveyor belt 224.

If all the vials 216 are in such a position that the vials 216 to be evacuated are standing on the evacuating conveyor belt 224, the sword 238 is caused to move upward about 0.5 mm to 20 mm, preferably 2 mm, thus lifting the vials 216 projecting beyond the transfer plane 210 so that these vials 216 are no longer in touching contact with the evacuating conveyor belt 224. Now, the evacuating conveyor belt 224 can be caused to move and the separated vials 216 can be evacuated for further processing.

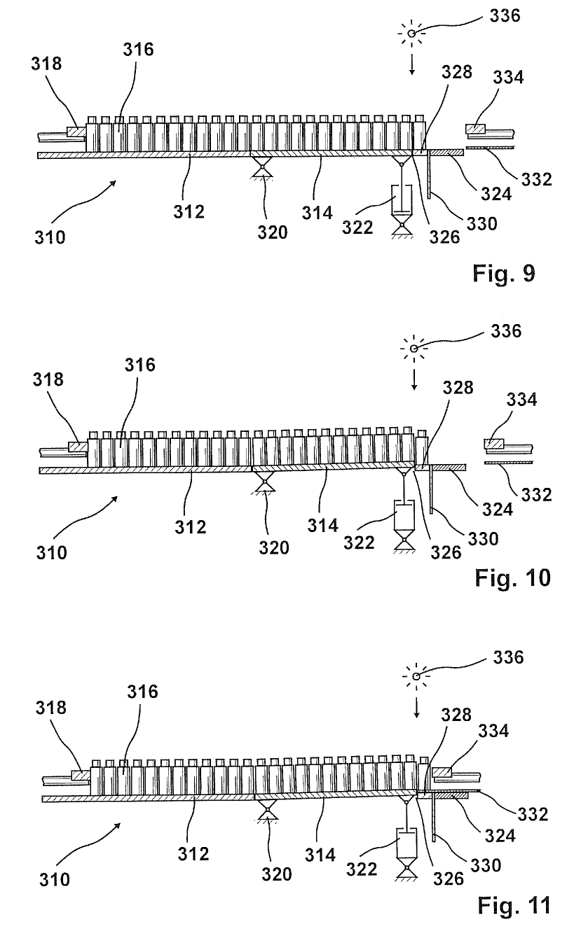

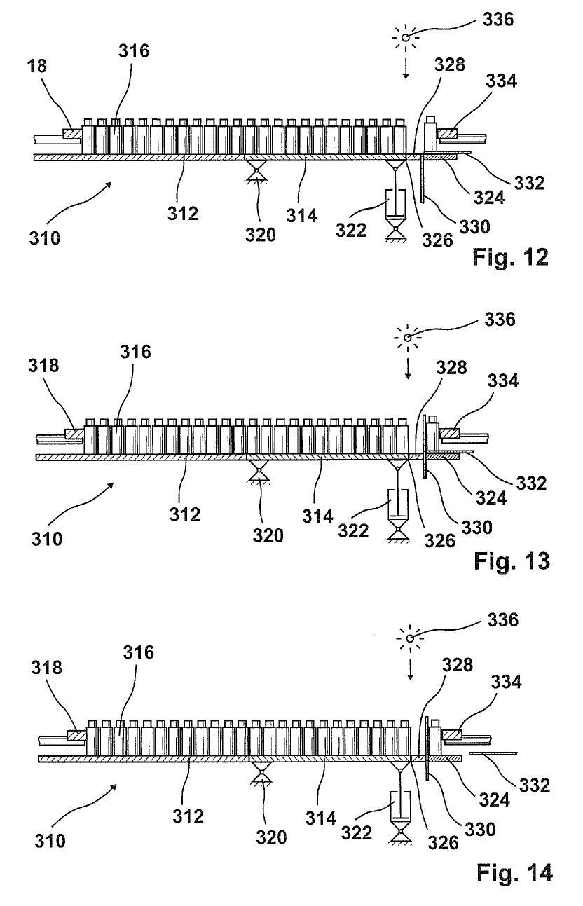

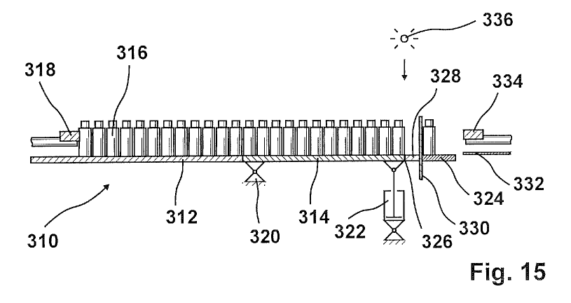

In the FIGS. 9 through 15, there is illustrated a third embodiment of an apparatus of the invention for controlled evacuation of a number of vials 316 after their having been evacuated from a freeze-drying plant, the same apparatus being shown in all the 7 Figs., respectively at different moments in time. This apparatus incorporates a transfer plane 310 made from two parts, a rigid part 312 and a pivotally carried part 314. On this transfer plane 310, a number of vials 316 can be placed, which are pushed out of a freeze-drying plant by means of a discharge pusher 318. The part 314 of the transfer plane 310 is mounted for pivotal movement by means of a joint 320 and a reciprocating piston 322. The reciprocating piston 322 is thereby disposed in such a manner on an edge 326 of the part 314 of the transfer plane 310, which is turned toward an evacuating conveyor belt 324, that this edge 326 can be lifted about 0.5 mm to 20 mm, preferably 2 mm.

Between the transfer plane 310 and the evacuating conveyor belt 324 there is provided a buffer surface 328 onto which precisely one row of vials 316 can be placed. The transfer plane 310 and the buffer surface 328 form one uniform surface so that the vials 316 coming from the freeze-drier can be readily pushed onto the buffer surface 328.

Between the buffer surface 328 and the evacuating conveyor belt 324 there is provided a sword 330 that can be lowered as far as underneath the top side of the buffer surface 328, or underneath the top side of the evacuating conveyor belt 324. This sword 330 can be moved upward at need in order to secure against toppling the vials 316 to be placed onto the evacuating conveyor belt 324.

Furthermore, the apparatus of the invention still incorporates a very flat and thin transport means 332 and a pusher member 334. The transport means 332 can be brought close to the first row of vials 316 standing on the buffer surface 328 and can be engaged underneath them so that the first row of vials 316 can be brought onto the evacuating conveyor belt 324 by means of the transport means 332. To place the vials 316 on the evacuating conveyor belt 324, the pusher member 334 is then brought into position so that the transport means 332 so to say causes the vials 316 to glide along the pusher member for them to get onto the evacuating conveyor belt 324. Once placed on the evacuating conveyor belt 324, the vials 316 are evacuated for further processing.

Above the transfer plane 310 there is provided a light barrier 338, which detects the first row of vials 316 upon arrival on the buffer surface 328. The controlled evacuation of the vials will be described in close detail herein after.

The vials 316, which are filled with a certain product, are conducted into a freeze-drying plant in order for the product to be freeze-dried. Upon completion of the freeze-drying process, the vials 316 are usually closed and then evacuated from the freeze-drying plant by means of a discharge pusher 318. The vials 316 are thereby neatly placed in rows and documentation is established as to which vial 316 is standing in which position. Upon displacing the whole lot of vials 316 from the freeze-drying plant onto a transfer plane 310, the relative position of the vials 316 with respect to each other is maintained. As soon as the discharge pusher 318 has pushed this number of vials 316 so far forward that the foremost row of vials 316 has reached the buffer surface 328, this is detected by the light barrier 338 and a signal is delivered to the discharge pusher 318 so that the latter stops. Next, the reciprocating piston 322 is actuated in order to lift the part 314 of the transfer plane about 0.5 mm to 20 mm, preferably 2 mm. As a result, the edge 326 of part 314 of the transfer plane 310 is lifted and serves as an abutment for the first row of vials 316 placed on the buffer surface 328. Next, the flat transport means 332 is brought close and pushed underneath the first row of vials 316. The vials 316 are thereby prevented from sliding out of place since they now hit the edge 328 and cannot slide out of place.

As soon as the transport means 332 is completely brought underneath the first row of vials 316, the transport means 332 is pulled back, entraining the first row of vials 316. Once the transport means 332 has moved past the sword 330, said sword is moved upward and, at the same time, a pusher member 334 is brought close to the vials 316 from the other side. When the pusher member 334 is in position, the transport means 332 is pulled from underneath the vials 316 so that the vials 316 fall onto the evacuating conveyor belt 324. During this movement, the vials 316 already start to swing but cannot topple since the sword 330 on the one side and the pusher member 334 on the other side serve as a boundary and prevent them from toppling. Finally, the vials 316 located on the evacuating conveyor belt 324 are evacuated for further processing.

Now, the reciprocating piston 322 is again retracted so that part 314 of the transfer plane 310 is again flush with the buffer surface 328. Now, the discharge pusher 318 can push the vials located on the transfer plane 310 further forward until the foremost row of vials 316 reaches the buffer surface 328, which is in turn detected by the light barrier 338. Now, the next row of the vials 316 located on the buffer surface 328 can be evacuated in the same way.

Thanks to such a controlled transfer of the vials 316 from the transfer plane 310 to the evacuating conveyor belt 324, the relative position of the vials 326 with respect to each other is maintained so that the vials 316, which are then disposed one behind the other on the evacuating conveyor belt 324, can be associated with a certain location in the freeze-drying plant for best documentation of the freeze-drying process.

In another embodiment that has not been illustrated herein, two or more rows of vials can be placed onto an accordingly sized buffer surface and be transported by the transport means.

The apparatus described herein can be utilized successfully for the separation and the controlled evacuation of vials at any place of a plant for feeding and evacuating vials. Its utilization is not limited to vials that are just coming out of a freeze-drying plant.

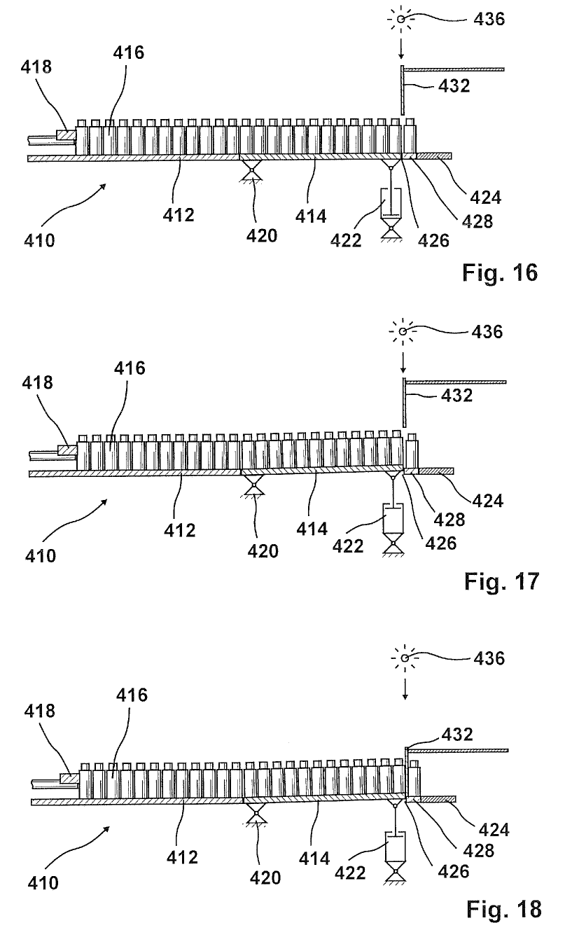

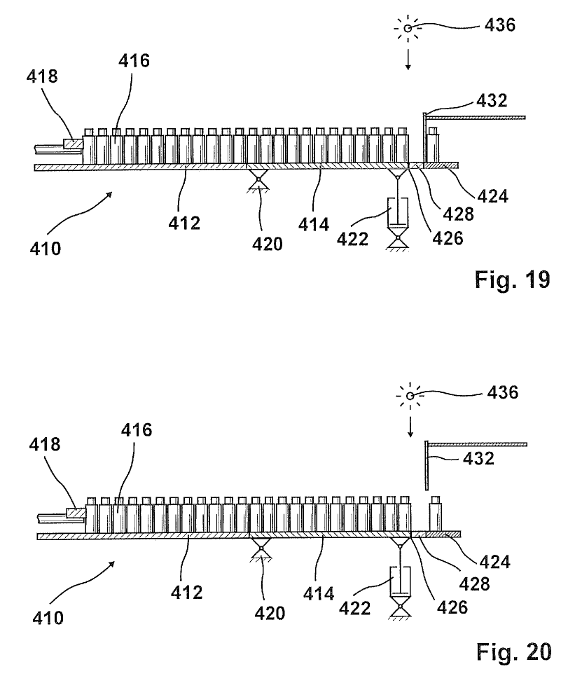

In the FIGS. 16 through 20, there is shown a fourth embodiment of an apparatus for separating a number of vials of the invention which incorporates a transfer plane 410 divided into two parts, one first solid part 412 and one second part 414, which is carried for pivotal movement on a joint 420 and a reciprocating piston 422. The transfer plane 410 is adjoined with a buffer surface 428 and said buffer surface 428 is adjoined with the evacuating conveyor belt 424. The top side of the transfer plane 410, of the buffer surface 428 and of the evacuating conveyor belt 424 are aligned flush with each other for a level surface to form.

Here again, all the vials 416 are pushed by a discharge pusher 418 so far onto the transfer plane 410 for a first row of vials 416 to come to stand on the buffer surface 428. This is detected by the light barrier 436, which stops the discharge pusher 418 accordingly. Next, the part 414 of the transfer plane 410 is pivoted in such a manner by the extending reciprocating piston 422 that a front edge 426 of part 410 is lifted about 0.5 mm to 20 mm, preferably 2 mm. As a result, the vials 416 still standing on the transfer plane 410 are separated from the vials 416 located on the buffer surface. Next, a transport means 432 is approximated from the top and is pushed between the vials 416 located on the transfer plane 410 and the vials 416 located on the buffer surface 428, as can be seen best from FIG. 18.

Next, the transport means 432 pulls the separated vials 416 onto the evacuating conveyor belt 424 for these vials 416 to be evacuated for further processing.

Although certain example methods and apparatus have been described herein, the scope of coverage of this patent is not limited thereto. On the contrary, this patent covers all methods, apparatus and articles of manufacture fairly falling within the scope of the appended claims either literally or under the doctrine of equivalents.

LIST OF NUMERALS

| | |
|---|---|
| 110, 210, 310, 410 | transfer plane |
| 112, 212, 312, 412 | part |
| 114, 314, 414 | part |
| 116, 216, 316, 416 | vials |
| 118, 218, 318, 418 | discharge pusher |
| 120, 320, 420 | joint |
| 122, 322, 422 | reciprocating piston |
| 124, 224, 324, 424 | evacuating conveyor belt |
| 126, 226, 326, 426 | edge |
| 128, 328, 428 | buffer surface |
| 130, 330 | sword |
| 132, 332, 432 | transport means |
| 134, 334 | pusher |
| 136, 236, 336, 438 | light barrier |
| 238 | sword |

We claim:

1. A method of separating a number of vials from a plurality of vials disposed in several rows comprising:
moving said vials disposed in several rows onto a transfer plane;
moving sais vials further beyond said transfer plane in order for the vials intended to be separated to reach a surface adjoining said transfer plane, via said transfer plane, and that the remaining vials remain on said transfer plane; and
at least one of lifting the vials still standing on said transfer plane adjacent the surface or lowering the surface in order for the vials remaining on the transfer plane not to touch the surface.

2. A method as set forth in claim 1, wherein the vials are at least one of lifted approximately 0.5 mm to approximately 20 mm or the surface is lowered approximately 0.5 mm to approximately 20 mm.

3. A method as set forth in claim 1, wherein the vials are separated row by row.

4. A method as set forth in claim 1, wherein the surface is at least one of a buffer surface or an evacuating conveyor belt.

5. An apparatus for separating a number of vials from a plurality of vials disposed in several rows comprising:
a transfer plane with a surface on which the separated vials may be placed, the transfer plane being at least partially carried so that it can be at least one of pivoted or lifted, such that one edge of the transfer plane, which is turned toward the surface, is lifted between approximately 0.5 mm and approximately 20 mm.

6. An apparatus as set forth in claim 5, wherein the surface is configured to be at least one of a buffer surface or an evacuating conveyor belt for evacuating the separated vials.

7. An apparatus as set forth in claim 5, further comprising:
a transporter for transferring the vials onto an evacuating conveyor belt; and
a buffer surface provided between the transfer plane and the evacuating conveyor belt, said buffer surface being configured to be so wide that at least one row of vials finds place thereon.

8. An apparatus as set forth in claim 5, wherein the transfer plane is made from at least two parts and the part adjacent the surface being mounted for pivotal movement.

9. An apparatus as set forth in claim 5, further comprising a light barrier disposed above the surface for detecting the arrival of the vials.

10. An apparatus for separating a number of vials from a plurality of vials disposed in several rows, comprising:
a transfer plane with a surface on which the separated vials may be placed; and
a lifting apparatus formed between the transfer plane and said surface, said lifting apparatus lifting at need the vials still standing on the transfer plane adjacent the surface at least partially between approximately 0.5 mm and approximately 20 mm.

11. An apparatus as set forth in claim 10, wherein the lifting apparatus is configured to be a vertically movable sword.

12. An apparatus as set forth in claim 10, wherein the surface is configured to be at least one of a buffer surface or an evacuating conveyor belt for evacuating the separated vials.

13. An apparatus as set forth in claim 10, further comprising:
a transport means for transferring the vials onto an evacuating conveyor belt, and
a buffer surface provided between the transfer plane and the evacuating conveyor belt, said buffer surface being configured to be so wide that at least one row of vials finds place thereon.

14. An apparatus as set forth in claim 10, wherein the transfer plane is made from at least two parts, the part adjacent the surface being mounted for pivotal movement.

15. An apparatus as set forth in claim 10, further comprising a light barrier disposed above the surface for detecting the arrival of the vials.
